(19) United States
(12) Patent Application Publication
(10) Pub. No.: US 2017/0336012 A1
(43) Pub. Date: Nov. 23, 2017

(54) PROTECTIVE COVER STRUCTURE OF WATER HOSE

(71) Applicant: Zhangzhou Leyuan Industrial Co., Ltd., Zhangzhou City (CN)

(72) Inventor: Wen Li Kuo, Zhangzhou City (CN)

(21) Appl. No.: 15/162,451

(22) Filed: May 23, 2016

(51) Int. Cl. F16L 57/00

(52) U.S. Cl. CPC F16L 57/005

(57) ABSTRACT

A protective cover structure of a water hose includes a water hose connector, a rigid protective cover, and at least one sealing member. The water hose connector has elasticity. A front end of the water hose connector is formed with a mating portion for connecting with a spray nozzle. A rear end of the water hose connector is formed with a concave step and a connecting portion. A rear end of the metallic press member is inserted into the water hose. A front end of the metallic press member is formed with a mating cap having an evaginated rim. The concave step of the water hose connector is movably mated with the metallic press member through the evaginated rim of the mating cap, such that the spray nozzle can be turned at will relative to the water hose and won't be turned reversely, twisted, bent.

### BACKGROUND OF THE INVENTION

### 1. Field of the Invention

The present invention relates to a water hose connector, and more particularly to a protective cover structure for connecting a gardening water hose connector with a spray nozzle.

### 2. Description of the Prior Art

In general, a conventional gardening spray nozzle is directly connected to a water hose through threads. When in use, the spray nozzle is often pulled, dragged, changed hand over hand, coiled, and so on. As a result, the water hose may be turned reversely, twisted, or bent. In particular, because the range of gardening activities is wide, the angle of rotation and oscillation of the spray nozzle is also relatively large. The twisted and bent water hose may be clogged, so water cannot flow smoothly. Sometime, the joint of the spray nozzle and the water hose may have a crack to cause a leak of water because the water hose is twisted and bent frequently. Accordingly, the inventor of the present invention has devoted himself based on his many years of practical experiences to solve these problems.

### SUMMARY OF THE INVENTION

The primary object of the present invention is to provide a protective cover structure to prevent a water hose from bending. The present invention can effectively prevent the amount of water and water pressure from reducing when the water hose is connected with a faucet because the water hose is pulled, dragged and bent. The protective cover structure prevents the water hose from being clogged and further prevents a leak of water or a crack of the water hose. The protective cover structure may function as an auxiliary handle when the water hose is locked to a faucet

In order to achieve the aforesaid object, a protective cover structure of a water hose according to the present invention comprises a water hose connector connected with the water hose, a rigid protective cover mated with an end of the water hose, and at least one sealing member disposed between the water hose and the water hose connector. The water hose connector is an elastic soft sleeve. A front end of the water hose connector is formed with a mating portion for connecting with a spray nozzle. A rear end of the water hose connector is formed with a connecting portion for connecting with the water hose. The protective cover structure further comprises a metallic press member for connecting the water hose with the water hose connector. The water hose connector is formed with a concave step therein. A seat at a rear end of the metallic press member is inserted into the water hose. A front end of the metallic press member is formed with a mating cap having an evaginated rim. The concave step of the water hose connector is movably mated with the metallic press member through the evaginated rim of the mating cap.

Preferably, the mating portion of the water hose connector is inner threads formed at the front end of the water hose connector to mate with the spray nozzle.

Preferably, the water hose connector is made of a plastic material, and the connecting portion is disposed beneath the concave step for insertion of the water hose.

Preferably, the connecting portion is formed with interlaced holes thereon.

Preferably, the rigid protective cover is a copper cover.

Preferably, an outer surface of the mating cap of the metallic press member is formed with an annular flange. An end face of the mating cap is formed with the evaginated rim. A groove is formed between the annular flange and the evaginated rim to mate with the concave step of the water hose connector.

Preferably, the sealing member is an O-shaped sealing ring.

Preferably, the inner threads of the front end of the water hose connector is directly formed in the water hose connector.

Preferably, the front end of the water hose connector is provided with a metallic union having inner threads.

Preferably, the mating portion at the front end of the water hose connector is a mating head having outer threads.

Accordingly, the present invention is provided with the elastic water hose connector, and the water hose connector is formed with the connecting portion to cover the water hose to strengthen the joint strength of the spray nozzle and the water hose so as to prevent the water hose from being bent a great angle relative to the spray nozzle to crack the water hose at the joint. The present invention is further provided with the metallic press member having the mating cap. A rear end of the metallic press member is fixed to the end of the water hose. By using the deformation of the evaginated rim of the mating cap to connect with the water hose connector, the structure of the present invention is simple. The water hose connector movably cooperates with the water hose, such that the spray nozzle can be turned at will relative to the water hose and won't be turned reversely, twisted or bent, preventing the water hose from being clogged and further preventing a leak of water or a crack of the water hose. Besides, when the water hose is locked to a faucet, the elastic water hose connector may function as an auxiliary handle for convenient use and operation.

### BRIEF DESCRIPTION OF THE DRAWINGS

FIG. 1 is an exploded view in accordance with a first embodiment of the present invention;

FIG. 2 is a sectional view in accordance with the first embodiment of the present invention;

FIG. 3 is a sectional view in accordance with a second embodiment of the present invention;

FIG. 4 is a side view in accordance with a third embodiment of the present invention; and

FIG. 5 is a sectional view in accordance with the third embodiment of the present invention.

### DETAILED DESCRIPTION OF THE PREFERRED EMBODIMENTS

Embodiments of the present invention will now be described, by way of example only, with reference to the accompanying drawings.

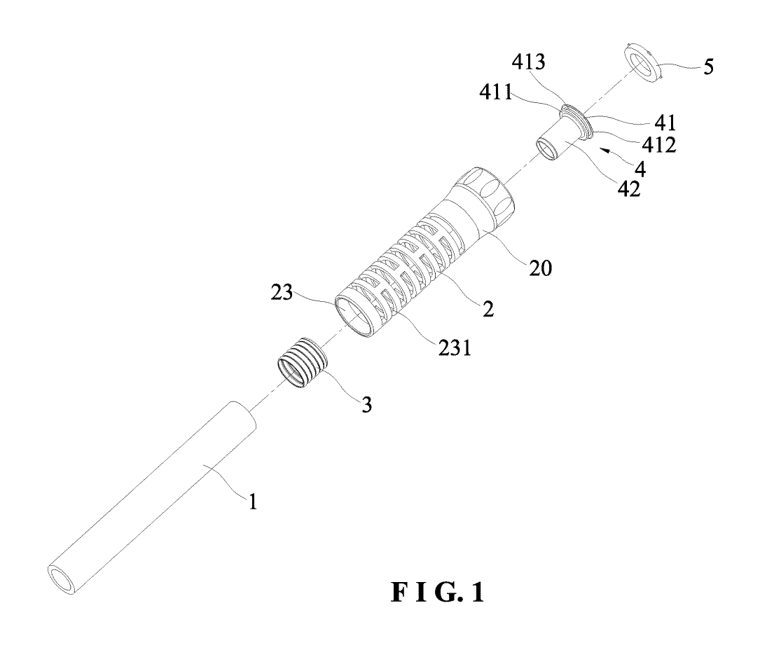

As shown in FIG. 1 through FIG. 5, the present invention discloses a protective cover structure of a water hose. The protection cover structure comprises a water hose connector 2 connected with the water hose 1, a rigid protective cover 3 mated with an end of the water hose 1, a metallic press member 4, and at least one sealing member 5. The metallic press member 4 and the sealing member 5 are adapted to connect the water hose 1 and the water hose connector 2.

The water hose connector 2 is an elastic soft sleeve. A front end of the water hose connector 2 is formed with a mating portion 20 for connecting with a spray nozzle (not shown in the drawings). A rear end of the water hose connector 2 is formed with a connecting portion 23 for connecting with the water hose 1. The elastic water hose connector 2 can enhance the joint strength of the spray nozzle and the water hose 1, preventing the water hose 1 being bent a great angle relative to the spray nozzle to crack the water hose at the joint.

In order to improve the capability of deformation for the water hose connector 2, the connecting portion 23 is formed with interlaced holes 231 to improve the flexibility of the spray nozzle for use.

The water hose connector 2 is made of a plastic material. An inner wall of the mating portion 20 of the water hose connector 2 has inner threads 21 to mate with the spray nozzle and a concave step 22 adjacent to a lower end of the inner threads 21. The connecting portion 23 is disposed in the water hose connector 2 beneath the concave step 22 for insertion of the water hose 1.

The rigid protective cover 3 is fitted on the outer surface of the front end of the water hose 1 to enhance the rigidness of the front end of the water hose 1. The rigid protective cover 3 is a copper cover.

The metallic press member 4 is a metallic bushing. A front end of the metallic press member 4 is formed with a mating cap 41 having an enlarged hole. A rear portion of the metallic press member 4 is formed with a seat 42 inserted into the water hose 1. An outer surface of the mating cap 41 is formed with an annular flange 411. An end face of the mating cap 41 is formed with an evaginated rim 412. A groove 413 is formed between the annular flange 411 and the evaginated rim 412 to mate with the concave step 22 of the water hose connector 2.

The sealing member 5 is installed between the concave step 22 of the water hose connector 2 and the spray nozzle to provide a sealing effect when the spray nozzle and the water hose connector 2 are tightened to press the sealing member 5. Meanwhile, the sealing member 5 is pressed against the evaginated rim 412 of the metallic press member 4 to provide a sealing effect among the water hose 1, the water hose connector 2, and the metallic press member 4. The sealing member 5 is an O-shaped sealing ring.

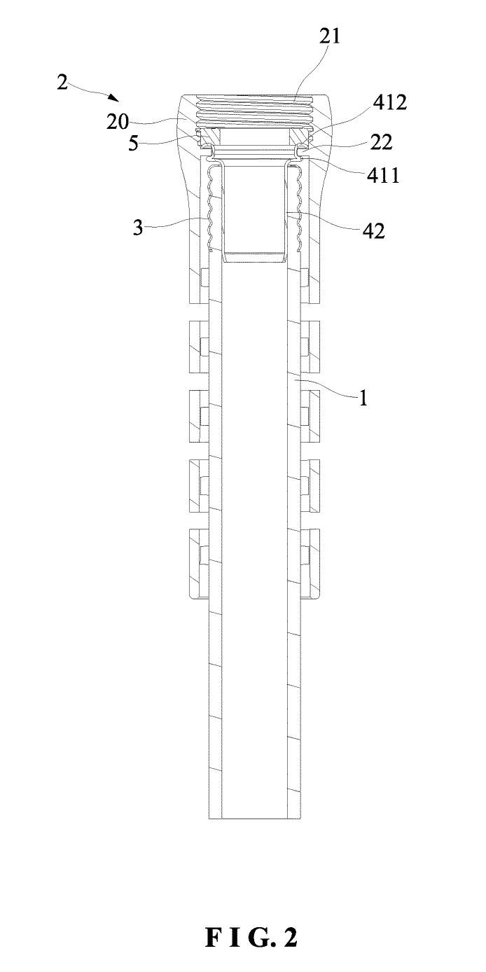

As shown in FIG. 2, to assemble the present invention, the seat 42 of the metallic press member 4 is embedded in the front end of the water hose 1 fitted with the protective cover 3 to form a fixing relationship between the metallic press member 4 and the water hose 1. The mating cap 41 extends out of the water hose 1. After that, the water hose connector 2 is fitted on the water hose 1. The lower end face of the concave step 22 is just against the annular flange 411 of the mating cap 41. By using a tool, the evaginated rim 412 of the mating cap 41 is deformed outward to buckle the upper end face of the concave step 22, such that the concave step 22 is confined in the groove 413 between the annular flange 411 and the evaginated rim 412 of the metallic press member 4 so as to connect the water hose connector 2 with the water hose 1. The water hose connector 2 can be coaxially turned relative to the water hose 1. Finally, the spray nozzle is connected to the water hose 1 with the outer threads of the water inlet of the spray nozzle to mate with the inner threads 21 of the water hose connector 2. When in use, the spray nozzle can be pulled, dragged, changed hand over hand, coiled, and so on. The water hose connector 2 is flexible relative to the water hose 1, so that the water hose 1 won't be twisted, bent or turned reversely to prevent the water hose 1 from being clogged or cracking, or a leak of water. Water can flow smoothly, and the spray nozzle can be used normally.

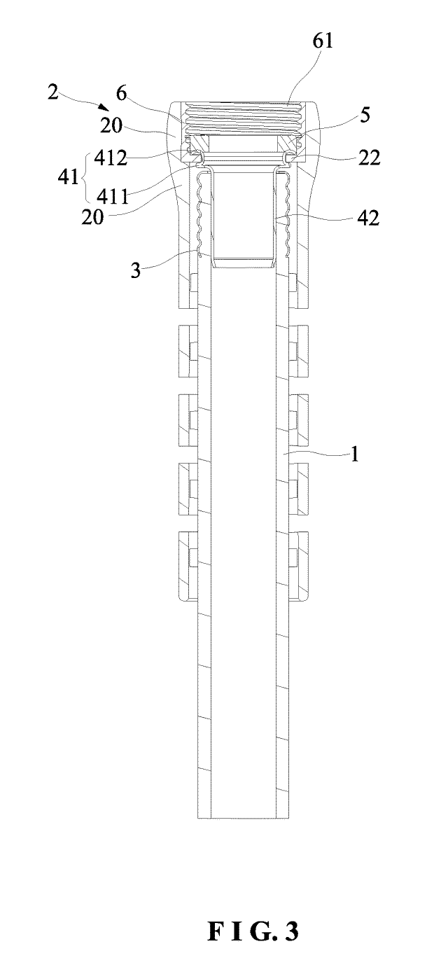

As shown in FIG. 3, the inner threads 21 of the front end of the water hose connector 2 can be directly formed in the water hose connector 2. Alternatively, the front end of the water hose connector 2 is provided with a metallic union 6 having inner threads 61. This also achieves the connecting function of the water hose connector 2 and the spray nozzle.

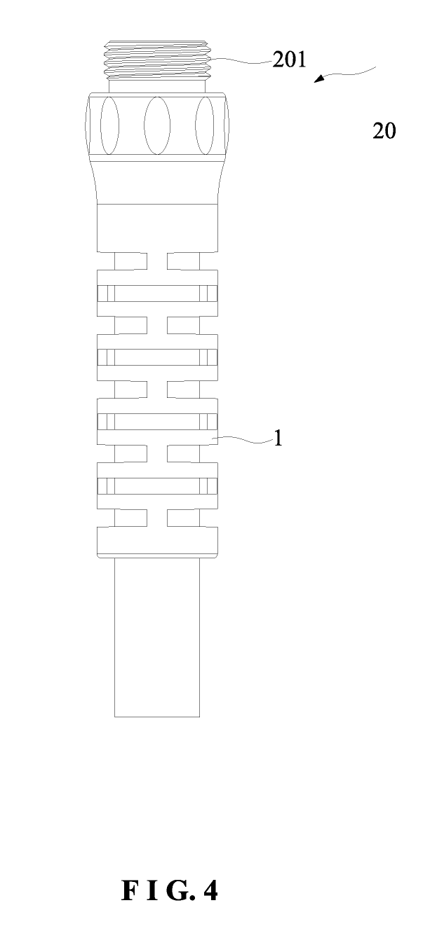

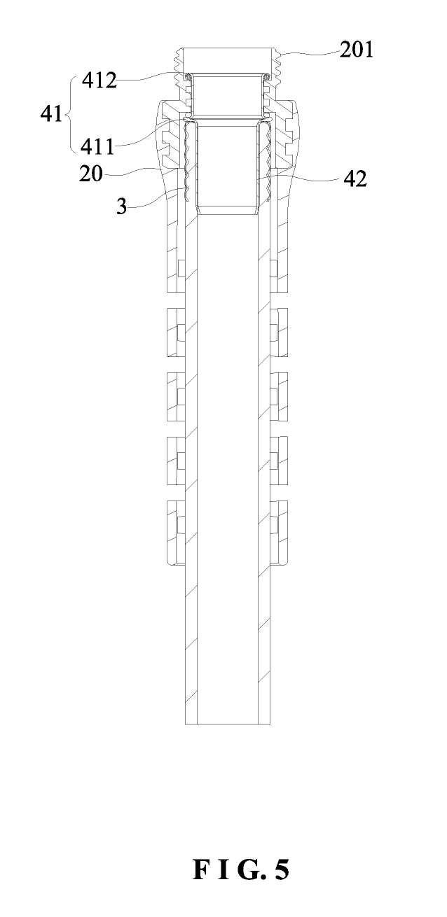

As shown in FIG. 4 and FIG. 5, the mating portion 20 at the front end of the water hose connector 2 can be a mating head 201 having outer threads. The mating head 201 extends outward from the front end of the water hose connector 2, which is able to connect with the spray nozzle having inner threads. The concave step is formed beneath the mating head 201 to cooperate with the metallic press member.

Accordingly, the present invention is provided with the elastic water hose connector 2, and the water hose connector 2 is formed with the connecting portion 23 to cover the water hose 1 to strengthen the joint strength of the spray nozzle and the water hose 1 so as to prevent the water hose 1 from being bent a great angle relative to the spray nozzle to crack the water hose at the joint. The present invention is further provided with the metallic press member 4 having the mating cap 41. By using the deformation of the evaginated rim 412 of the mating cap 41 to connect with the water hose connector 2, the structure of the present invention is simple. The water hose connector 2 movably cooperates with the water hose 1, such that the spray nozzle can be turned at will relative to the water hose 1 and won't be turned reversely, twisted or bent, preventing the water hose 1 from being clogged and further preventing a leak of water or a crack of the water hose 1. Besides, when the water hose 1 is locked to a faucet, the elastic water hose connector 2 may function as an auxiliary handle for convenient use and operation.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A protective cover structure of a water hose, comprising a water hose connector connected with the water hose, a rigid protective cover mated with an end of the water hose, and at least one sealing member disposed between the water hose and the water hose connector; characterized in that: the water hose connector is an elastic soft sleeve, a front end of the water hose connector is formed with a mating portion for connecting with a spray nozzle, a rear end of the water hose connector is formed with a connecting portion for connecting with the water hose; the protective cover structure further comprises a metallic press member for connecting the water hose with the water hose connector; the water hose connector is formed with a concave step therein; a seat at a rear end of the metallic press member is inserted into the water hose, a front end of the metallic press member is formed with a mating cap having an evaginated rim, the concave step of the water hose connector is movably mated with the metallic press member through the evaginated rim of the mating cap.

2. The protective cover structure of a water hose as claimed in claim 1, wherein the mating portion of the water hose connector is inner threads formed at the front end of the water hose connector to mate with the spray nozzle.

3. The protective cover structure of a water hose as claimed in claim 1, wherein the water hose connector is made of a plastic material, and the connecting portion is disposed beneath the concave step for insertion of the water hose.

4. The protective cover structure of a water hose as claimed in claim 1, wherein the connecting portion is formed with interlaced holes thereon.

5. The protective cover structure of a water hose as claimed in claim 1, wherein the rigid protective cover is a copper cover.

6. The protective cover structure of a water hose as claimed in claim 1, wherein an outer surface of the mating cap of the metallic press member is formed with an annular flange, an end face of the mating cap is formed with the evaginated rim, and a groove is formed between the annular flange and the evaginated rim to mate with the concave step of the water hose connector.

7. The protective cover structure of a water hose as claimed in claim 1, wherein the sealing member is an O-shaped sealing ring.

8. The protective cover structure of a water hose as claimed in claim 1, wherein the inner threads of the front end of the water hose connector is directly formed in the water hose connector.

9. The protective cover structure of a water hose as claimed in claim 1, wherein the front end of the water hose connector is provided with a metallic union having inner threads.

10. The protective cover structure of a water hose as claimed in claim 1, wherein the mating portion at the front end of the water hose connector is a mating head having outer threads.
